(19) United States
(12) Patent Application Publication
(10) Pub. No.: US 2016/0353542 A1
(43) Pub. Date: Dec. 1, 2016

(54) Lighted door knob with lighted keyhole and lighted door frame and including motion detector and music or sounds

(71) Applicant: Linda M. Orr, Saint Louis, MO (US)

(72) Inventor: Linda M. Orr, Saint Louis, MO (US)

(21) Appl. No.: 14/721,220

(22) Filed: May 26, 2015

(51) Int. Cl. H05B 33/08; E05B 47/00; E05B 17/22; E05B 41/00; H05B 37/02; E05B 17/10

(52) U.S. Cl. CPC H05B 33/0854; H05B 37/0218; H05B 37/0227; H05B 33/0857; E05B 17/10; E05B 17/226; E05B 41/00; E05B 47/0001; E05B 2047/0048; E05B 2047/0097

(57) ABSTRACT

For the main safety purpose of assisting the blind or nearly blind and the hard of hearing individuals in this world, this invention has been created.

An illuminated doorknob and keyhole brightens when in motion. The illumination level is dependent both on the ambient light level and on the motion of the doorknob. Specifically, the ambient light level determines a static brightness when the doorknob is not in motion, and the doorknob illumination brightens above the static brightness when turned. Various embodiments of the invention may provide an illuminated doorknob, door frame, door handle, door keyhole, door lock, music accent or light pulsation with or without color, when doorknob is moved, or a combination thereof on an exterior door, or an illuminated doorknob on an interior door. A remote control device containing a memory chip will control light and music when activated.

### PATENT CITATIONS

| | |
|---|---|
| U.S. Pat. No. 4,477,570 | Switch for controlling the operation of a |
| | light source in response to the presence of a |
| | moving person or object and in response to |
| | the magnitude of ambient light not provided |
| | by the light source |
| U.S. Pat. No. 4,777,570 | Illuminated doorknob lock |
| U.S. Pat. No. 5,398,175 | Illuminated door knob lock |
| U.S. Pat. No. 6,622,537 | Deadbolt with LED and wiring harness |
| U.S. Pat. No. 6,461,013 | Door knob lighting assembly |
| U.S. Pat. No. 6,584,818 | Interconnected lock with lock status sensor |
| U.S. Pat. No. 6,774,505 | Vehicle switch assembly with proximity |
| | activated illumination |
| U.S. Pat. No. 6,305,814 | Keyhole lighting fixture |
| U.S. Pat. No. 4,890,093 | Solar powered proximity triggered light |
| U.S. Pat. No. 5,057,975 | Apparatus for illuminating a keyhole |
| U.S. Pat. No. 5,179,325 | Touch-sensitive illuminable door lock |
| U.S. Pat. No. 6,363,763 | Lock with sensor |
| US20140260449 | Wireless lockset with integrated antenna, |
| | touch activation, and light communication |
| | method |
| U.S. Pat. No. 6,370,929 | Apparatus for insertion of a key therein |
| U.S. Pat. No. 5,724,106 | Hand held remote control |
| U.S. Pat. No. 6,940,493 | Socializing remote communication |
| U.S. Pat. No. 6,601,984 B2 | Led illuminating device and lighting |
| | apparatus employing the same |
| U.S. Pat. No. 7,057,153 | Multiple sensing automatic lighting system |
| | for personal safety |
| U.S. Pat. No. 6,023,224 | Door frame with integrated keyless entry |
| | system |
| U.S. Pat. No. 7,476,002 B2 | Color changing light devices with active |
| | ingredient and sound emission for mood |
| | enhancement |
| U.S. Pat. No. 7,922,348 | Luminous handle for doors, furnishings, |
| | means of transport or the like |
| US20100192650 | Self-adjusting cylinder monitor assembly |

### BACKGROUND OF THE INVENTION

1. Field of the Invention

The present invention relates to a doorknob and/or door frame containing an LED illuminating device employing an LED element comprising at least one light source connected to a microchip to produce an area of emitted light. The present invention further relates to lighting apparatus employing the LED illuminating device as a light source.

2. Description of the Related Art

At present, numerous light sources using electric power to emit light have been developed with practical applications. In general though, light from these sources has a small area of illumination. In order to achieve effective illumination within a desired area, therefore, these light sources must employ a means for reflecting or diffusing light, such as a reflecting plate, or be used together with a condenser lens or diffusion lens.

By their nature, LED's (light-emitting diodes) emit light through a light-emission surface without diffusion. In other words, they can emit what are known as parallel light beams. Conventionally, LED's have primarily been used for indicators or pilot lamps, wherein the light of the LED itself conveys a meaning.

LEDs can also notably be incorporated in light sources of a cylindrical transparent member material as described in Japanese unexamined patent application publication No. H9-163080. The transparent member material is provided on one end with a light reader for reading light from an LED and on the other end with a reflecting surface. Lenses are formed in the transparent member material by cutting isosceles-triangle shapes in the member material with a knurling tool.

Technology now allows consumer products to include audio messaging producing means such as a microchip connected to a speaker as described in U.S. Pat. No. 5,796,328, which produces an audio message, when activated. U.S. Pat. Nos. 6.298,990 and 5,992,629 describe containers having a sound chip that is activated by a light sensor such that the sound chip that is activated by a light sensor that is activated by movement. U.S. Pat. No. 5,130,696 describes a container incorporating a sound-generating device that is activated by a light sensor, upon movement, to emit a preprogrammed sequence of sounds. U.S. Pat. No. 5,923,242 to Slage et al, also discloses a light activated sound-providing device which is secured to the interior of a container.

### SUMMARY OF THE INVENTION

The present invention is directed toward safety by presenting an illuminated doorknob and door frame which may also containing sound. The illumination level is dependent both on the ambient light level and on the motion of the doorknob. Specifically, the ambient light level determines a static brightness when the doorknob is not in motion, and the doorknob illumination brightens above the static brightness when turned. Various embodiments of the invention may provide an illuminated doorknob, doorframe, door handle, lock, various sounds, various music selections, various light pulsations, or a combination thereof on an exterior door, or an illuminated doorknob on an interior door.

According to the present invention, there is provided an LED illuminating device which includes a rod-shaped light guiding member material consisting of a translucent material; and an LED element have at least one light emitting diode and disposed at an end of said light-guiding member material in the longitudinal direction and at least one light-guiding member material in the cylindrical direction. Reflection of the light from said LED element to the outer sides of longitudinal direction and reflection of the light from the cylindrical direction will complete the cylindrical direction and the longitudinal direction.

The invention is directed to a package having a sound generating device, which can be incorporated into the opening mechanism configured to produce sound upon engagement of the microprocessor or microchip. The opening mechanism activates the sound when the opening mechanism is activated by movement such as a rotation turn to the right. Various musical and static sound selections contained in a microchip can be installed in small opening in the package. Sound selections are numerous and by choice of the consumer.

### DESCRIPTION

The present invention relates to locksets and door frame, and more particularly to exterior locksets wherein the keyhole area, doorknob portion, and/or door frame can be illuminated and sound activated to facilitate entrance.

In addition, responsive illumination may be extended to lighting elements surrounding the exterior of the home or building (front, back, and sides); for example beneath eaves or surrounding windows or other exterior features. Additionally, responsive lighting elements may be placed throughout the interior of the home or building. Multiple responsive lighting elements may be linked via wireless or wired electronic communication, and additional inputs, for example back and side doors.

The first and second exemplary embodiments are intended for installation as original equipment by the manufacturer of the door FIG. 8. Alternate embodiments, which may be intended for installation as after-market modifications by the user or by a home repair and remodeling service, are also contemplated.

The first exemplary embodiment provides a doorknob, lock, rose cover, rose insert spindle, screw inserts, and other components which are customary in doorknobs. The doorknob provides an illuminated ring on its side surfaces, a slot for music/sound microchip, and the interior of the lock is also illuminated, such that the light shines outward through the keyhole. Illumination is referably provided by light emitting diodes (LEDs). The rose cover provides a recessed motion sensor and a light dependent resistor(LDR). A contact switch or sensor is connected to the doorknob such that when the doorknob is turned, the contact switch/sensor is activated.

The doorknob and its components are preferably powered by a direct connection to standard house current, via a power cord through the door and door frame. Emergency back-up power, for use during power failures, is preferably by a battery pack concealed within the door which is accessible via a concealed access panel on the side surface of the door near the hinges. The battery pack contains one or more replacement batteries.

The doorknob provides variable illumination of the illuminated ring and the interior of the lock, visible via the keyhole, the music/sound chip controlled by the motion sensor, the LDR, and the contact switch. The LDR detects the ambient light level and adjusts the illumination level in inverse proportion to the level of ambient light. In complete darkness, the illumination which is provided is dim, but sufficient to clearly see the lock and doorknob, such as 10 candlepower. In cases where ambient light exists but is insufficient to clearly see the lock and the doorknob such that they may be easily used, additional illumination is provided which is sufficient to supplement the ambient light up to the desired dim visibility level. In bright ambient light, such as daylight, the illumination is deactivated.

Under certain circumstances a substantially brighter level of illumination is provided, such as 20 candlepower. The brighter level of illumination is activated by the motion detector, upon detection of a human body or similarly size object near the, or by the contact switch or sensor, upon the turning of the doorknob. The brighter level of illumination is deactivated when the motion detector and the contact switch do not provide activation signals for a predetermined period, such as 30 seconds.

The second exemplary embodiment provides activation devices and power supplies similar to the first exemplary embodiment. However, the second exemplary embodiment provides no doorknob, rose cover, or related hardware, instead providing a deadbolt lock and separate handle. The lock provides internal illumination visible through the keyhole, as with the first exemplary embodiment. The door frame and the handle also provide illuminated surfaces. Certain areas, panels, or embellishments on the front surface of the door may also be illuminated. The contact switch is activated by the turning of a key in the keyhole, and the motion detector and LDR are provided in the handle.

The first and second exemplary embodiments may be provided with LEDs in any one of a variety of colors and coordinated color patterns or pulsations. Such pattern displays as an illuminated ring in light and a key hole in yellow, may be provided. Alternate embodiments, providing LEDs in multiple colors and coordinated color patterns for holiday display or other purposes, are contemplated. Such additional colors and coordinated color combinations may include orange for Halloween, red and green for

Christmas, or red, white, and blue for the Fourth of July. Selection of a different color or color pattern is preferable controlled from a concealed control module on the side surface of the remote control or is contemplated to be controlled on the side surface of the door near the battery pack.

These alternate embodiments may also provide recorded music, an assortment of sounds, such as fireworks released at the Fourth of July or bells ringing at Christmas time, a flashing pattern in the illumination, or both to accompany the brighter level of illumination. The recorded music may be consistent with holiday themes, such as “Jingle Bells” for Christmas, or “Yankee Doodle Dandy” for the Fourth of July. The control module for the such alternate embodiments may include one or more speakers or microphone, a microprocessor, and a memory device to store and play digital music files.

To use the first or second exemplary embodiment, the user simply installs the microchip or selects choices on the control module. The doorknob and other components operate automatically.

The doorknob, the lock, the rose cover, the rose insert, the spindle, the screw inserts, the hinges, and the battery pack are preferable manufactured from rigid durable materials such as steel, aluminum alloy, brass, and brushed nickel. The illuminated ring and other illuminated surfaces are preferable manufactured from a rigid, durable material which is translucent, such as acrylic polymer or plastic. The door and door frame are preferably manufactured from a rigid durable material such as wood, aluminum alloy or steel. The power cord an other cords are preferably manufactured from braided copper alloy wire sheathed in plastic. The microchip, sensors, microprocessor, microphone, or speakers are comprised of plastic and copper wire. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. Truly the safety issues illustrated are instrumental in improving the accessability to entrances by assisting the hard of hearing and those who are visibly challenged with the daily trials of living. The invention should, therefore, not be limited by the above described embodiment, method, and examples, but by all embodiments and methods within the scope and spirit of the invention.

It is an object of the present invention to provide a keyhole area light in a lockset and a portion of the doorknob which senses that a person is approaching the door and illuminates the keyhole light and door knob and may also emit sound or music. A contact switch/sensor is connected to the doorknob 10, such that when the doorknob is turned, the contact switch/sensor is activated. Other objects and advantages of the present invention will become apparent from the following portion of the specification and from the attached drawings which disclose, in accordance with the mandate of the patent statutes, a presently preferred embodiment of the invention.

### REFERRING TO THE DRAWINGS

FIG. 1 is an oblique separated view of the exterior deadbolt portion of a handleset;

FIG. 2 is a side oblique view of the interior coverplate for the handleset in association with a door FIG. 8 and key hole in door knob 11 with illuminated translucent ring 11A door knob with hard plastic ring 10A and music/sound microchip in grip access portion of doorknob 10;

FIG. 3 is a rear view of the coverplate shown in FIG. 2;

FIG. 4 is a logic diagram for the turn lever light control circuit of the handleset;

FIG. 5 is a logic diagram for the motion detection circuit of the handleset.

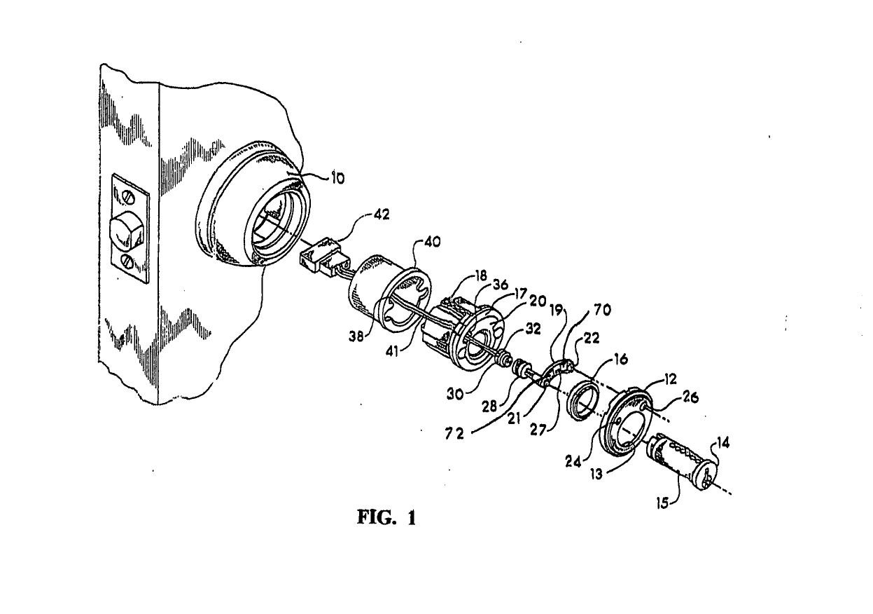

The upper deadbolt which is shown in FIG. 1, includes a cylinder guard cover 10 which is closed by a cylinder cover 12. The opening 13 in the cylinder cover 12 receives the face 14 of the cylinder plug 15 and an annular serrated translucent ring 16 which extends around the plug face. Positioned between the cylinder cover and the front flange 17 of the cylinder body 18 is an electronic module 19 (the electronic module is received within a recess 20 defined in the front flange of the plug body 17) which has an integrated photocell light sensor 21 for detecting ambient light and an integrated motion detection sensor 22, which detect the environment through two holes 24, 26 in the cylinder cover and an integrated light emitting diode (L.E.D.) 27. The ring L.E.D., when activated, emits light radial from the electronic module which has a curved inner surface that mates with the outer annular surface of the serrated translucent ring so that light emitted from the serrated translucent ring will illuminate the keyhole area (the serrated translucent ring projects slightly outwardly from the cylinder cover to increase the amount of light directed to the keyhole area), emits light from the translucent ring around the doorknob, and emits translucent light from the door frame. The electronic module is connected to the power source by means of a 3-circuit flexible circuit 30 routed through the cylinder body and the bored hole in the door (to protect the connection of the flexible circuit to the electronic module a cylindrical stop can be secured to the flexible circuit which is trapped by a reduced diameter shoulder in the bore through the cylinder body). The flexible circuit is connected to the power source (one or more batteries or microchip containing sounds and light color and pulsations).

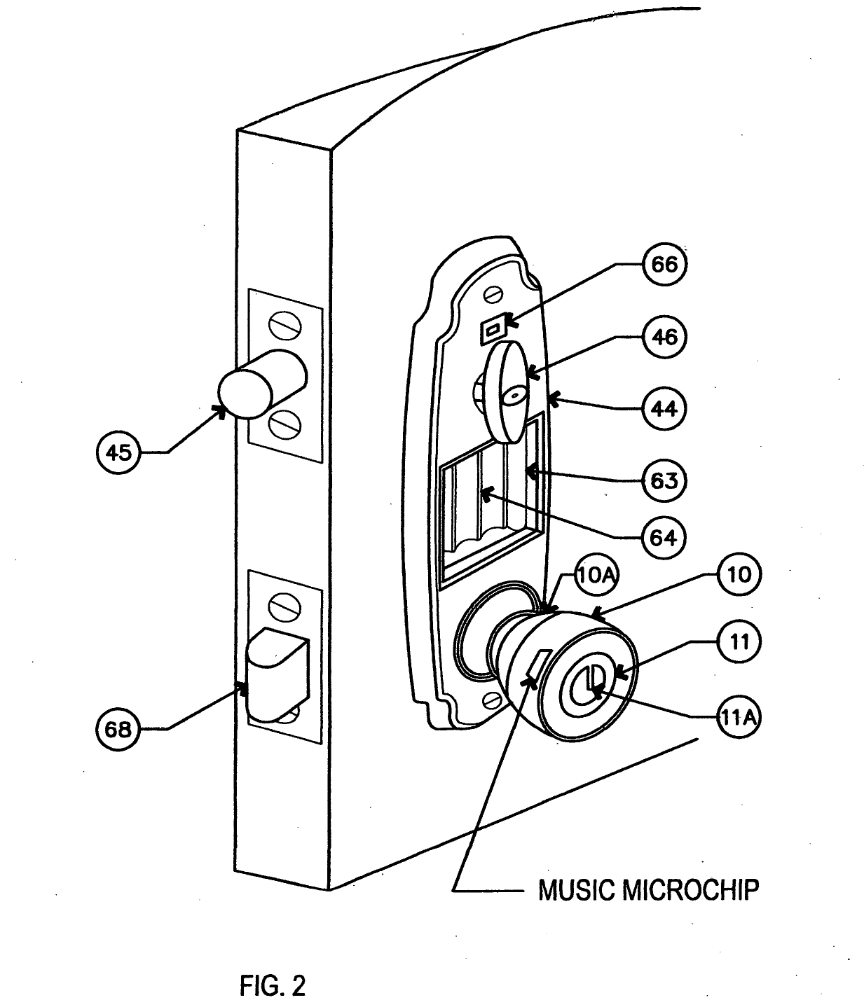

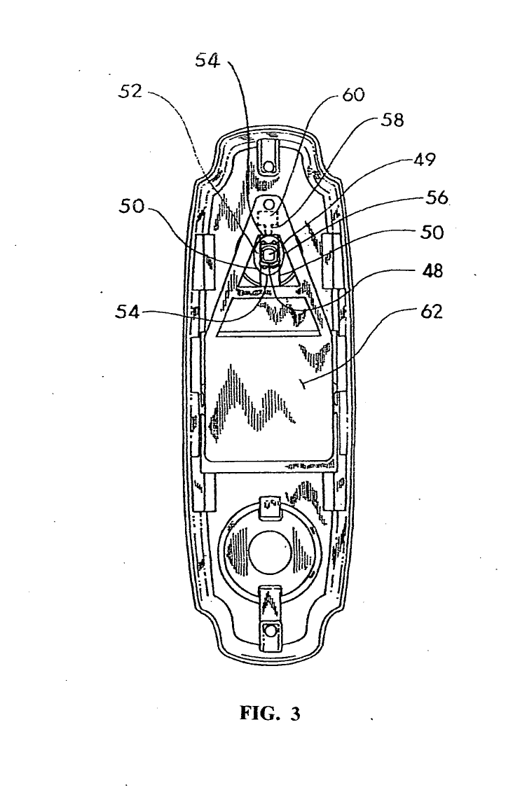

The interior cover plate 44 is shown in FIG. 2. The upper deadbolt 45 is controlled from the inside by a turn lever 46 which can be turned front the illustrated vertical locked position to a horizontal unlocked position. As can be seen from FIG. 3, a square block 48, which is secured to the shaft 49 of the turn lever, is captured by a pair of parallel strip springs 50 so that the turn lever will be stable at either position. Also secured to the turn lever shaft is a cam 52 which has a pair of 180 degree related high spots 54 and a pair of 180 degree related low spots 56. When the turn lever is vertical a high spot will be at the top of the cam and when the turn lever is horizontal a low spot will be at the top of the cam. The actuator 58 of a switch 60 follows the cam and operates the switch, which is connected to the wiring harness, when the turn lever is vertical. The switch, which is mounted on a carrier 62 secured to the interior cover plate, is connect to the electronic module. Also mounted on the carrier is a support 64 for a plurality of batteries or microchip, which contains light colors and pulsations and sounds (one shown 63) which power the electronics. An access plate (not shown) closes the opening in the interior cover plate. Also connected to the wiring harness is an interior L.E.D. 66 which is mounted on the interior cover plate. The lockset also includes an interior operator 67 which operates the bolt 68 of a latch assembly.

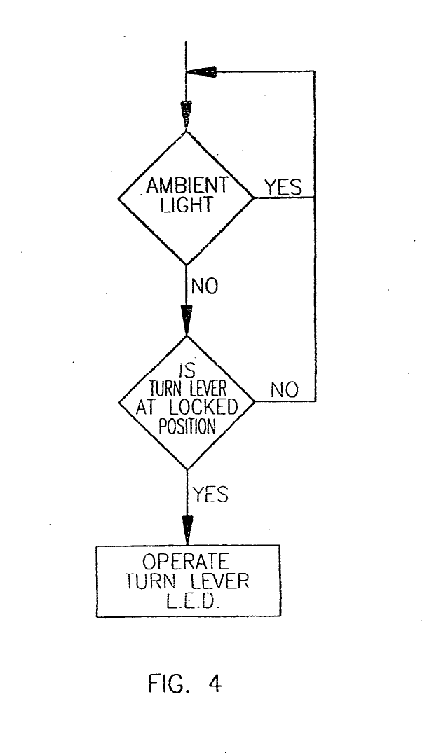

FIG. 4 illustrates the logic diagram for the turn lever L.E.D. 66 which is connected to the electronic module. The photo cell light sensor 21 associated with the deadbolt determines when it is dark outside. If this sensor determines that it is dark and if the turn lever is at a vertical position thereby operating the switch, the turn lever L.E.D. 66 will be illuminated. The color and intensity of this L.E.D. will be selected so that it can be seen in the dark to confirm that the door is locked. Alternatively, the turn lever L.E.D. can be illuminated during both daylight and nighttime whenever the turn lever is turned to the locked position.

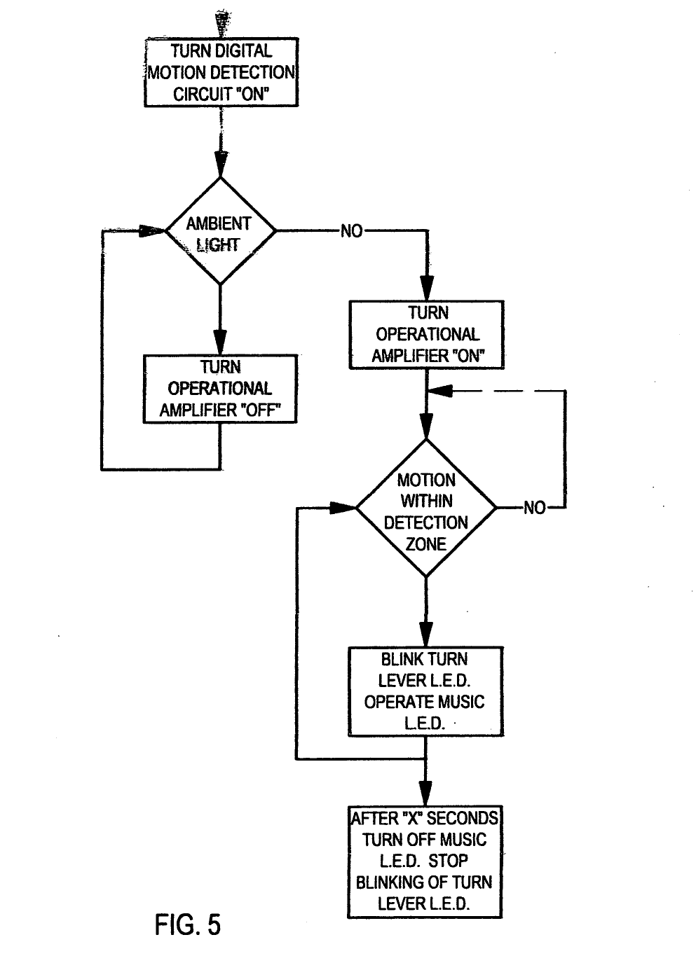

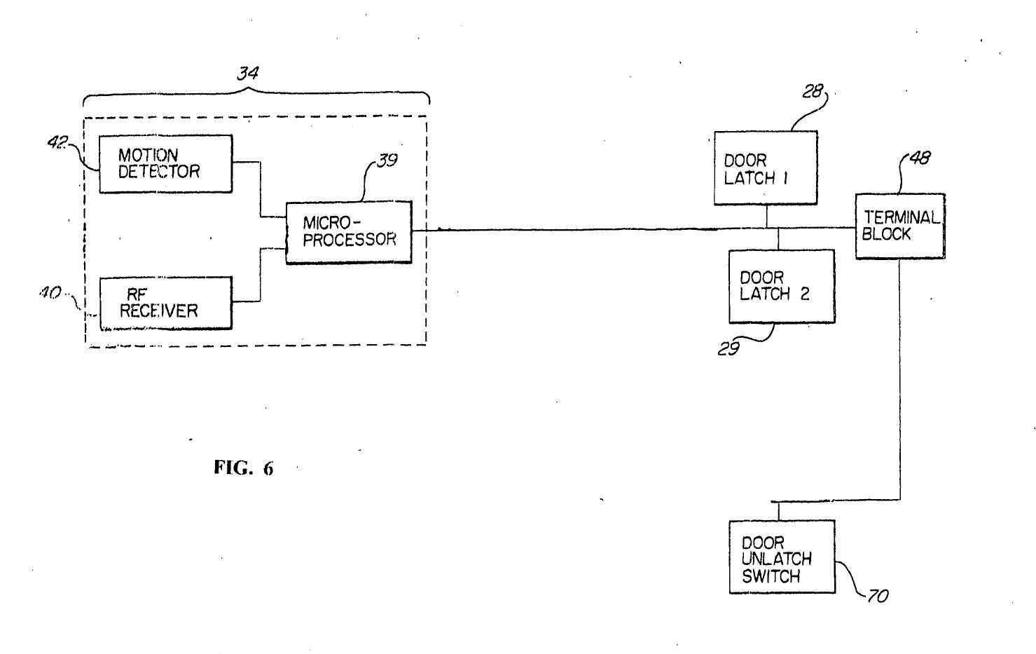

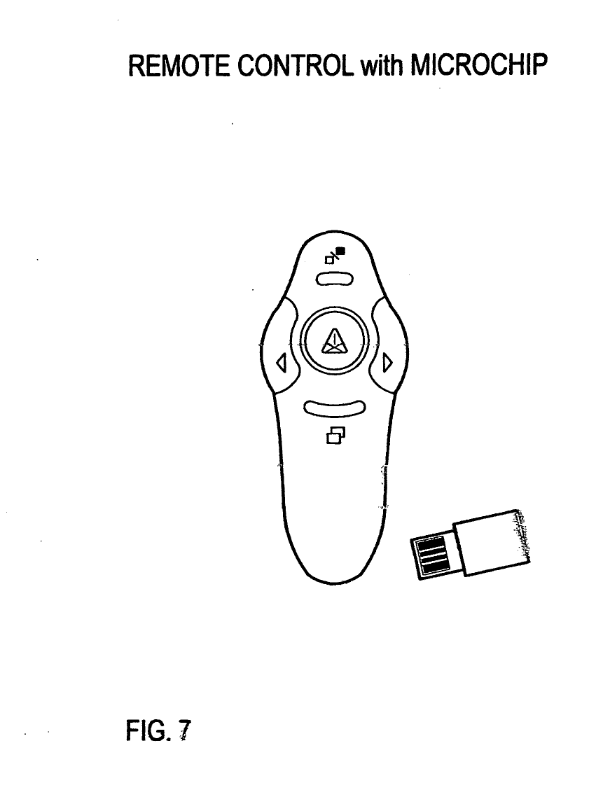

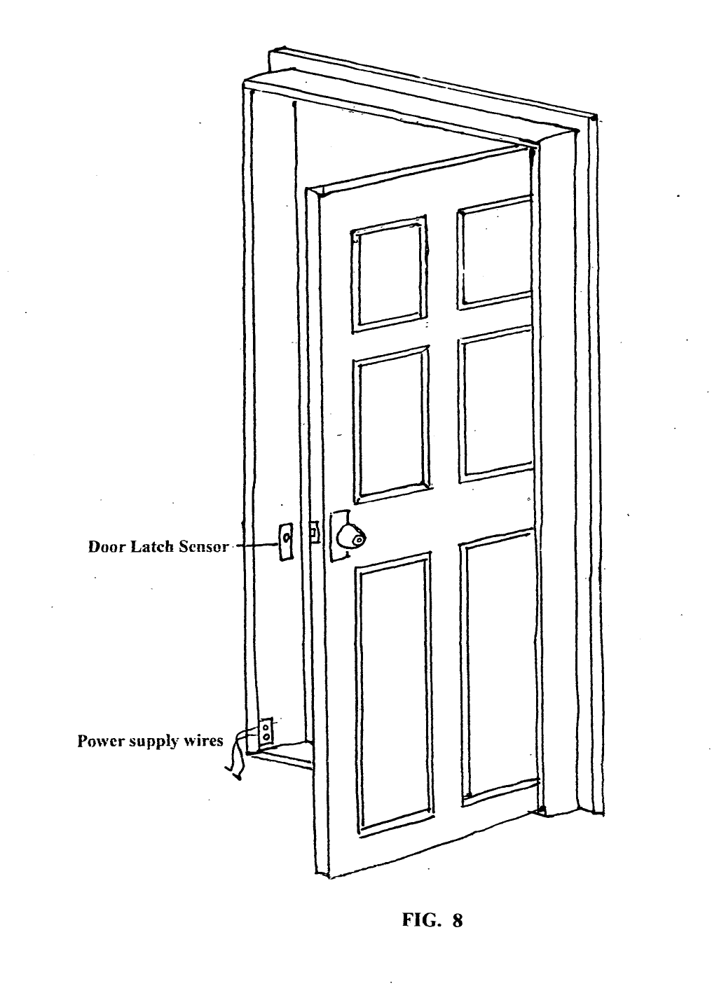

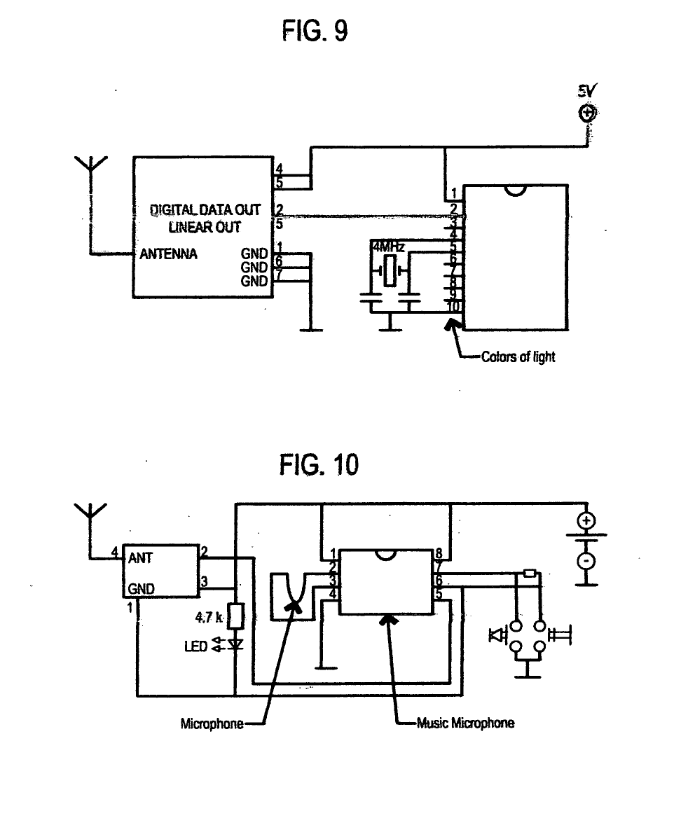

Referring to FIG. 5, the motion detection circuit has a lock operated digital portion for determining whether the light sensor sees ambient light and whether the motion detection sensor sees motion and an analog portion (an operational amplifier) which can supply energy to operate the L.E.D.s for a selected period of time (30 seconds, for example) while recharging during that time to operate the L.E.D.s, if required, for another 30 seconds.

FIG. 6, illustrates a sensor and control module 34 comprising a microprocessor or microchip 39 for controlling the operation of the system, a radiant energy receiver 40, and a motion detector 42, which reads the transmitted signal from the sensor and control module and unlatches both the first and second electromechanical door latches 28, 29 so that the door FIG. 8 can be pushed open.

FIG. 7, a small wireless remote control unit is carried by a user. The remote control unit transmits a signal of a type compatible with radiant energy receiver, which operates in the radio frequency band and utilize a pulse-modulation coding technique as used in U.S. Pat. No. 4,141,040. The remote control unit and receiver preferably make use of a “rolling code” technology, which eliminates the possibility of the receivers, the light and music control microchips, being activated by any transmission other than that of the companion remote control unit. The remote control contains at least one slightly depressed button which, when activated, allows the light to be turned on or off, and a side button to allow the music to be turned on or off from a plurality of light stored and music stored in the microchip memory. Memory contained of light and colors of light to be static or pulsating. Memory chip of music will be assorted holiday and event songs. A memory chip of music and light assortments will be available to consumer.

FIG. 8, is a drawing of an open door showing the door latch sensor and the power supply wires, which could be run into a home's lower level or under floors to reach another room needing an illuminated doorknob with or with sound.

FIG. 9, the invention comprises a light sensor or motion detector that is coupled to the light control circuitry, wherein the light control circuitry microchip adjusts the color scheme based upon ambient light intensity or detected motion.

FIG. 10, the invention further comprises a microphone that is coupled to the music or sound microchip wherein the music or sound choice based upon consumer choices is selected by the choice of music or sound microchip installed in the doorknob.

A LED driver circuit is shown in FIG. 10 and is controlled by a microcontroller or microchip. An eligible remote control device containing a receiver will transmit the signal for chosen music and/or light pulses of choice are shown in FIG. 9, which is also driven by a microcontroller or microchip.

The doorknob comprising a remote control wirelessly coupled to the light and sound circuitry and the microchip being wirelessly coupled to the light and sound circuitry by the remote when a memory card is received in the remote control slot. The doorknob contains a light sensor or motion detector that is coupled to the light and sound circuitry adjusts the light and sound based upon ambient light intensity, motion detection, and consumer choice. The light control circuitry adjusts the color scheme based upon ambient light intensity or detected motion.

The motion detection circuit can operate in either of two modes: a sleep mode where, while the digital circuit is “on,” the operational amplifier (analog circuit) is “off ” and a standby mode where both the digital circuit and the operational amplifier are “on.”

When ambient light is sensed, the system will operate in the sleep mode (if operation in this mode is permitted) and when ambient light is not sensed, the system will operate in the standby mode. When the operational amplifier is “on” motion within the detection zone will operate both the ring and turn lever L.E.D.s. After they operate for a set period (30 seconds, for example), they turn off and if motion is still detected in the detection zone, they will again be operated, etc. Since the turn lever can be continuously on as a result of it being in the locked position the turn lever L.E.D. will blink when it is operated in response to motion being detected in the detection zone. Alternately, a separate L.E.D., which could have a unique color, could be used to indicate such motion.

Both the analog circuit 70 and the digital circuit 72 are within the electronic module 19. To minimize current use when an L.E.D. is on, a current minimizing circuit disclosed in U.S. patent application Ser. No. 08/554,070, filed Nov. 11, 1995, and may be used.

1. A lockset comprising:
a cylinder plug including a key receiving slot,
a cover assembly for enclosing said cylinder plug, said cover assembly including
a cover having a central opening and having first and second holes therein,
a central translucent ring having a portion located within said central opening and having an outer annular surface, and an electronic module disposed beneath said cover assembly and selectively configured to matingly engage said outer annular surface of said translucent ring, said electronic module including light source means including an L.E.D. for radially directing light at the outer annular surface of said central translucent ring to illuminate said central translucent ring, a first sensor for sensing ambient light, said first sensor located in said first hole, a second sensor for sensing motion within a detection range, said second sensor located in said second hole, and an electronic circuit disposed within said electronic module and operable for illuminating said light source means when said first sensor senses ambient light below a predetermined level and said second sensor senses motion within the detection range, said electronic circuit including
a first circuit responsive to an output of said first sensor and operable for switching said second sensor between a sleep mode when said ambient light is above said predetermined level and a standby mode when said ambient light is below said predetermined level,
a second circuit responsive to an output of said second sensor generated when said second sensor is in said standby mode, and a third circuit responsive to said second circuit and operable for illuminating said L.E.D.

2. A lockset according to claim 1, further comprising of a battery source and microchip, which contains sounds and light colors and pulsations, means for powering said electronic module.

3. A lockset according to claim 2, further comprising a cylinder body for said cylinder plug, and said cylinder body including a front flange portion having a recess for receiving said electronic module.

4. A lockset according to claim 3, further comprising connection means for connecting said microchip, which contains sounds and light colors and pulsations or battery source means to said electronic module, a cylinder housing for said cylinder body, and aligned holes in said cylinder housing and in said front flange portion of said cylinder body for receiving said connection means.

5. A lockset comprising:
a cylinder plug including a key receiving slot,
a cover assembly for enclosing said cylinder plug including
a cover having a central opening and a first hole and a second hole,
a translucent ring having a portion located within said central opening between said cylinder plug and said cover,
a cylinder body for receiving said cylinder plug, said cylinder body including a front flange, and a circuit module located between said front flange and said cover including
a first sensor located in said first hole for sensing ambient light,
a second sensor located in said second hole for sensing motion within a detection range, light source means located proximate said translucent ring to illuminate said ring, and said circuit module containing a first circuit responsive to an output of said first sensor and operable for switching said second sensor between a sleep mode when an ambient light condition is above a predetermined level and a standby mode when said ambient light condition is below said predetermined level, a second circuit responsive to an output of said second sensor generated when said second sensor is in said standby mode, and a third circuit responsive to said second circuit and operable for illuminating said light source means.

6. A lockset according to claim 5, wherein said translucent ring includes an annular surface defining the outer diameter of said ring and said circuit module has an inner surface for engaging with said annular ring surface, said circuit module supporting said light source means proximate said annular ring surface.

7. A lockset according to claim 6, wherein said circuit means is adapted to operate said light source means when said second sensor senses ambient light below a predetermined level and said first sensor senses motion within said detection range.

8. A lockset according to claim 7, wherein said front flange of said cylinder body includes a recess for receiving said circuit module.

9. The lockset according to claim 1 further including an interior cover plate and a portable power source contained within said interior cover plate for supplying electrical power to said electronic module.

10. The lockset of claim 5 further including an interior cover plate and a portable power source contained within said interior cover plate for supplying electrical power to said circuit module.

11. A self-contained illuminating lockset comprising:
a cylinder assembly including a cylinder body and a cylinder plug;
a cover having a central opening, a first hole and a second hole formed therein;
a translucent ring having a portion located within said central opening adjacent said cylinder plug and an outer annular surface;
an electronic module disposed beneath said cover and having an inner annular surface matingly engaging said outer annular surface of said translucent ring, said electronic module including:
an L.E.D. disposed along said inner annular surface and operable to radially direct light toward said outer annular surface of said translucent ring for providing illumination thereof;
a light sensor located in said first hole and operable to sense an ambient light condition;
a motion sensor located in said second hole and operable to sense motion within a detection range;
an activation circuit disposed within said electronic module and operably coupled to said first sensor and said second sensor for determining whether said ambient light condition is below a predetermined level and whether motion is detected within said detection range; and
an illumination circuit disposed within said electronic module and operably coupled to said L.E.D. for illuminating said L.E.D. only when said ambient light condition is below said predetermined level and motion is detected within said detection range.

12. The lockset according to claim 11 wherein said activation circuit is operable in a sleep mode wherein said light sensor is operable while said motion sensor and said L.E.D are inoperable, and wherein said activation circuit is further operable in a standby mode wherein said light sensor, said motion sensor and said L.E.D. are operable.

13. The lockset according to claim 11 further including an interior cover plate and a portable power source contained within said interior cover plate for supplying electrical power to said electronic module.
